(19) United States
(12) Patent Application Publication
(10) Pub. No.: US 2005/0054287 A1
(43) Pub. Date: Mar. 10, 2005

(54) Apparatus and method for dividing MMS message in a mobile terminal

(75) Inventor: Byung-Soo Kim, Gyeonggi-Do (KR)

Correspondence Address: JONATHAN Y. KANG, ESQ.;LEE, HONG, DEGERMAN, KANG & SCHMADEKA, P.C., 14 Floor, 801 S. Figueroa Street, Los Angeles, CA, 90017-5554, US

(73) Assignee: LG Electronics Inc.

(21) Appl. No.: 10/936,047

(22) Filed: Sep. 7, 2004

(30) Foreign Application Priority Data
Sep. 6, 2003 (KR) 2003-0062389

(51) Int. Cl. H04H 1/00

(52) U.S. Cl. 455/3.05

(57) ABSTRACT

An apparatus and method for dividing an MMS message in a mobile terminal capable of dividing an MMS message exceeding transmission capacity of a server to a size that can be transferred. By implementing a multi-thread of a shooting thread and a dividing thread, an image signal and a voice signal inputted when shooting video are encoded, divided, stored and then transmitted so that a multimedia data as large as available for a mobile terminal can be transmitted as an MMS regardless of transmission capacity of an MMS server.

### CROSS-REFERENCE TO RELATED APPLICATIONS

This application claims the benefit of Korean Application No. 2003-0062389 filed on Sep. 6, 2003, which is hereby incorporated by reference.

### BACKGROUND OF THE INVENTION

1. Field of the Invention

The present invention relates to a mobile terminal and, more particularly, to an apparatus and method for dividing an MMS message of a mobile terminal.

2. Description of the Related Art

In general, MMS (Multimedia Messaging Service) means a service of transmitting and receiving messages including various multimedia data such as pictures, photos, voice, music or video as well as simple text to and from a wired/wireless mobile terminal of a user.

The user can transmit an MMS message with relatively large capacity to a terminal of the other party through the MMS. However, recent improvement in performance of mobile terminals allows users to store multimedia files such as larger capacity video or music compared to the past, but as the MMS server providing the MMS, the existing server with transmission capacity of about merely 100 Kbytes is still used. Thus, a multimedia file with large capacity that exceeds the transmission capacity of the MMS server cannot be transmitted to the terminal of the other party.

In order to solve the problem, a method for differently limiting the storage size of the multimedia file such as video according to a use purpose has been proposed.

FIGS. 1 and 2 shows an example showing a related art method for differently limiting the storage size of the multimedia file.

As shown in FIG. 1, in case of shooting and storing standard type video, the video can be stored up to limit capacity designated for a memory of the terminal (about 128 Mbytes in case of the up-to-date mobile terminal), and ordinarily, however, the video file exceeds the transmission capacity of the MMS server in most cases, MMS transmission is not possible as shown in the below picture of FIG. 1.

With reference to FIG. 2, if video is shot and stored for the purpose of MMS transmission, the video is divided into smaller-sized video (that is, a size below MMS transmission capacity) and then stored in a buffer or in a memory for MMS transmission.

As mentioned above, in transmitting multimedia file through MMS, the related art fails to transmit the large size of file due to the transmission (available) capacity of the MMS server, and the proposed related art which has been devised to overcome the problem causes user's inconvenience because MMS transmission-available file and MMS transmission-unavailable file are mixed.

### SUMMARY OF THE INVENTION

The present invention is directed to an apparatus and method for dividing image and/or voice signals and transmitting the divided image and/or voice signals as an MMS (Multimedia Messaging Service) message in a mobile terminal such that an MMS message exceeding a transmission capacity of an MMS server may be transmitted by the mobile terminal.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the present invention is embodied in a mobile communication device that allows image and/or voice signals that exceed the capacity of an MMS server to be transmitted as multiple frame files as an MMS message. Specifically, the image and/or voice signals are encoded as multimedia data and divided into multiple frame files such that each of the multiple frame files corresponds to a determined capacity of an MMS server and the multiple frame files are transmitted as MMS messages. Although the invention is described herein with regard to dividing an MMS message, it is contemplated that the invention may be utilized anytime it is desired to transmit a message having a size that that exceeds the capacity of a specific server.

In one aspect of the invention, an apparatus is provided for dividing a MMS message in a mobile terminal. The apparatus includes an input unit, a controller, a buffer unit, a memory unit and an RF (Radio Frequency) unit.

The input unit receives an image signal and/or a voice signal. The controller controls the mobile and encodes the image and voice signals received by the input unit into multimedia data, divides the multimedia data into a plurality of multimedia data portions with each portion having a specific size, assigns a sequence number to the plurality of multimedia data portions and stores the plurality of multimedia data portions. The buffer unit stores the encoded multimedia data and the plurality of multimedia data portions. The memory unit stores the plurality of multimedia data portions stored in the buffer unit according to the assigned sequence number. The RF (Radio Frequency) unit wirelessly transmits the plurality of multimedia data portions stored in the memory unit.

Preferably, the input unit includes a camera adapted to receive an image signal and/or a microphone adapted to receive a voice signal. An output unit may be provided for outputting operation information of the mobile terminal and either an image signal and/or a voice signal under the control of the controller.

Preferably, the specific size of the plurality of multimedia data portions is smaller than a one-time transmission-available capacity of an MMS server utilized to transmit the MMS message. It is contemplated that the memory unit may include a RAM (Random Access Memory) to store the plurality of multimedia data portions upon receiving a control signal from the controller.

Preferably a multi-thread is implemented by the controller in order to encode the image and voice signals into multimedia data, store the multimedia data in the buffer unit, divide the multimedia data into the plurality of multimedia data portions and store the plurality of multimedia data portions the buffer unit. It is contemplated that the multi-thread may include a shooting thread and a dividing thread.

The shooting thread receives the image and voice signals, stores the multimedia data in the buffer unit and outputs the multimedia data to the output unit. The dividing thread retrieves the multimedia data stored in the buffer unit, divides the retrieved multimedia data into a plurality of multimedia data portions each having a specific size and stores the plurality of multimedia data portions in the buffer unit. Preferably, the specific size of the plurality of multimedia data portions is smaller than a one-time transmission-available capacity of an MMS server utilized to transmit the MMS message.

Preferably, the buffer unit comprises a first buffer and a second buffer. The first buffer temporarily stores the encoded multimedia data. The second buffer divides and encodes the multimedia data stored in the first buffer to generate the plurality of multimedia data portions and temporarily stores the plurality of multimedia data portions under the control of the controller.

If the controller implements a multi-thread, the multimedia data is stored in the first buffer and the plurality of multimedia data portions having a specific size are stored the second buffer. If the multi-thread includes a shooting thread and a dividing thread, the shooting thread stores the multimedia data in the first buffer and the dividing thread stores the plurality of multimedia data portions having a specific size in the second buffer. Preferably, the specific size of the plurality of multimedia data portions is smaller than a one-time transmission-available capacity of an MMS server utilized to transmit the MMS message.

It is contemplated that the controller may include a table unit for defining and assigning a sequence number to the plurality of multimedia data portions. If the memory unit includes a RAM, each of the plurality of multimedia data portions is stored, with a sequence number assigned by the table unit, in a corresponding region of the RAM upon receiving a control signal from the controller.

In another aspect of the invention, a method is provided for dividing an MMS message in a mobile terminal. The method includes determining a transmission capacity of an MMS server when inputting image and/or voice signal begins, encoding the image and voice signals, storing the encoded image and voice signals as multimedia data in a first buffer, dividing the multimedia data by the determined transmission capacity of the MMS server to generate multiple frame files, storing the multiple frame files in a second buffer and transmitting the multiple frame files as an MMS message when inputting of the image and voice signals is completed.

Preferably, a multi-thread performs the encoding and dividing. It is contemplated that the multi-thread may include a shooting thread and a dividing thread.

The shooting thread encodes and converts the image signal and voice signals and stores the encoded image and voice signals as multimedia data in the first buffer. The dividing thread divides the multimedia data stored in the first buffer by frame units having a predetermined size and stores the multiple frame files in the second buffer.

It is contemplated that the method may include informing a user of the mobile terminal that the transmitted MMS message comprises multiple frame files. It is further contemplated that a header of the transmitted MMS message may include information regarding the multiple frame files being transmitted, such as the number of frame files, an order assigned to the frame files and/or the determined transmission capacity of the MMS server.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIGS. 1 and 2 illustrate a related art method for differently limiting the storage size of a multimedia file.

FIG. 3 shows a concept of a method for dividing an MMS message in a mobile terminal in accordance with the present invention.

FIG. 4 illustrates the construction of an apparatus for dividing an MMS message in a mobile terminal in accordance with a preferred embodiment of the present invention.

FIG. 5 is a flow chart of a method for dividing an MMS message in a mobile terminal in accordance with the preferred embodiment of the present invention.

FIG. 6A to 6C illustrate a user interface of a mobile terminal adopting the present invention.

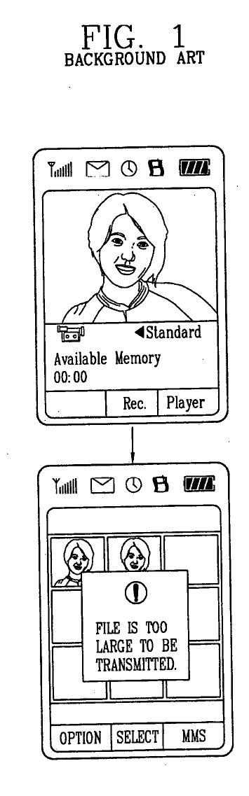

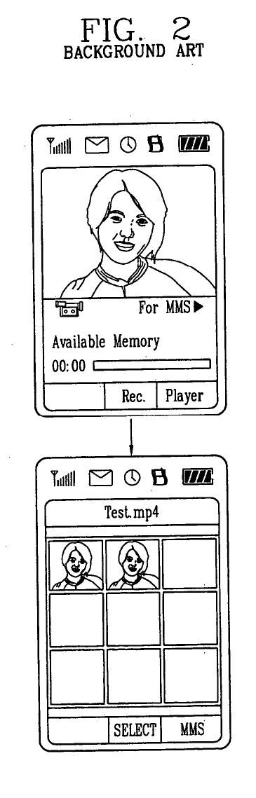

### DETAILED DESCRIPTION OF THE PREFERRED EMBODIMENTS

The present invention is directed to an apparatus and method for dividing image and/or voice signals and transmitting the divided image and/or voice signals as an MMS (Multimedia Messaging Service) message in a mobile terminal such that an MMS message exceeding a transmission capacity of an MMS server may be transmitted by the mobile terminal. Although the present invention is illustrated with respect to a mobile communication device, it is contemplated that the present invention may be utilized anytime it is desired to transmit a message having a size that that exceeds the capacity of a specific server.

In describing the present invention, if a detailed explanation for a related known function or construction is considered to unnecessarily divert the gist of the present invention, such explanation has been omitted but would be understood by those skilled in the art.

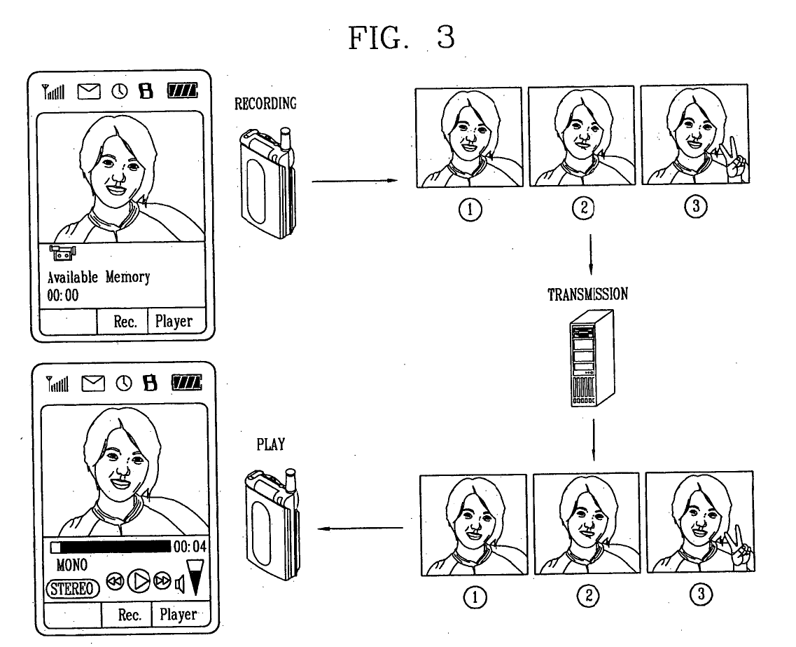

FIG. 3 illustrates a concept for dividing an MMS message in a mobile terminal in accordance with the present invention. When the terminal records, it divides the video into files suitable to one-time MMS transmission size and stores the files internally.

For example, if the one-time MMS transmission available capacity is 100 Kbytes, the recorded video is divided into files of 100 Kbytes each and stored. When an MMS message is transmitted, the terminal transmits the divided files to another terminal used by another party through an MMS server multiple times.

FIG. 3 illustrates transmission of three divided files. However, files may be divided and transmitted as many times as necessary based on the storage capacity of the transmitting terminal and the one-time MMS transmission size. For example, if video storage capacity available for the transmitting mobile terminal is 1 Mbytes, the number of files that may be divided and transmitted is a maximum of 10 assuming the one-time MMS transmission available capacity of 100 Kbytes. In newer terminals, the number of files may exceed 10, but the number of divided/transmitted files may be limited to ensure smooth operation of the server.

After the receiving terminal receives each file through the MMS server and a user of the receiving terminal reproduces the received files, the files are successively reproduced as a single file. A header of the MMS message may include information regarding the divided files, such as the number, order and/or capacity of the files.

The video captured by the transmitting terminal is divided into a size suitable for one-time MMS transmission size. The generated file may be ‘mp4’ as a file suitable for encoding video of the mobile terminal.

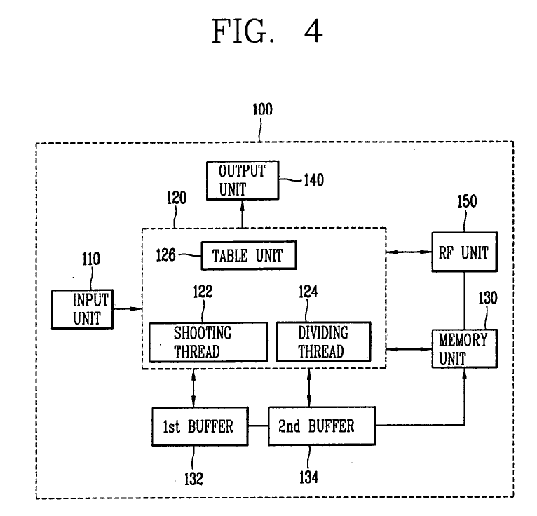

FIG. 4 illustrates an apparatus 100 for dividing an MMS message in a mobile terminal according to one embodiment of the present invention. The apparatus 100 includes an input unit 110 installed in the mobile phone, a controller 120 for controlling each part of the mobile terminal 100, a first buffer 132, a second buffer 134, a memory unit 130, an output unit 140 and an RF (Radio Frequency) unit 150.

The input unit 110 receives an image signal and/or a voice signal. The controller 120 encodes the image signal and/or voice signal received by the input unit 110 to multimedia data, divides the multimedia data into multiple portions each having a specific size, assigns a sequence number to the each of the divided multiple portions and stores the multiple portions.

The first buffer 132 temporarily stores the encoded multimedia data. The second buffer 134 divides and encodes the multimedia data stored in the first buffer to generate each multiple portion file and temporarily stores the multiple portion files under the control of the controller 120.

The memory unit 130 stores each multiple portion file temporarily stored in the second buffer 134 according to the sequence order. The output unit 140 outputs operation information of the mobile terminal 100 and an image signal and/or a voice signal under the control of the controller 120. The RF unit 150 wirelessly transmits the files stored in the memory unit 130.

The image inputted through the input unit 110 is divided into a size suitable for the one-time MMS transmission size and stored in the second buffer 134. The controller 120 is connected to a corresponding base station in order to check an available transmission capacity, for example signal processing capacity, of the MMS server. The controller 120 may include a table unit 126 for defining and assigning a sequence number of the divided multimedia data.

The input unit 110 may include a camera for receiving an image signal and/or a microphone for receiving a voice signal. The controller 120 may be an MSM (Mobile Station Modem) or a processor which implements a multi-thread in order to encode the image signal and/or voice signals from the input unit to multimedia data, store the multimedia data in the first buffer, divide the multimedia data and store the divided multimedia data in the second buffer.

The multi-thread may include a shooting thread 122 and a dividing thread 134. The shooting thread 122 receives the image and/or the voice signals, stores the received image and/or the voice signals as multimedia data in the first buffer 132 and outputs the multimedia data to the output unit. The dividing thread 134 retrieves the multimedia data that has been stored by the shooting thread 122, divides the retrieved multimedia data to a specific frame unit size and stores the divided multimedia data in the second buffer 134.

The first buffer 132 temporarily stores the multimedia data under the control of the controller 120. The second buffer 134 stores and outputs the multimedia frame file which has been divided into frame units. The multimedia data having is encoded and converted by the shooting thread 122 and stored in a corresponding allocated region of the first buffer 132 and the multimedia frame file is divided into frame units by the dividing thread 124 and stored in a corresponding allocated region of the second buffer 134.

The memory unit 130, which may be a RAM (Random Access Memory), stores the divided multimedia frame files with a sequence number assigned by the table unit 126 upon receiving a control signal from the controller 120. The output unit 140 may be a display unit for outputting the image signal and/or a speaker for outputting the voice signal.

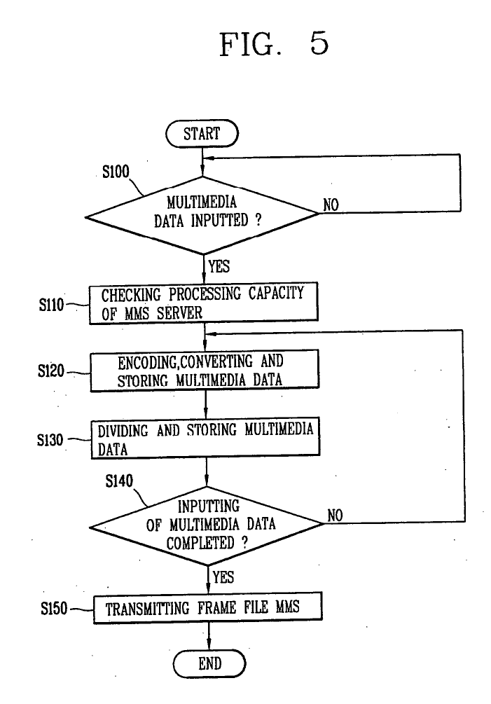

FIG. 5 illustrates a flow chart of a method for dividing an MMS message in a mobile terminal in accordance with one embodiment of the present invention. When an image signal and/or a voice signal are inputted through the input unit 110 of the mobile terminal 100, (S100), for example when a user starts recording with a camera mounted in the mobile terminal, the mobile terminal is connected to a corresponding base station and transmission capacity of the MMS server is checked (S110). Specifically, the mobile terminal 100 checks one-time MMS transmission capacity allowing transmission of the image and/or the video signals as a message.

When the image signal and/or voice signal are inputted by the input unit 110 of the mobile terminal 100, the inputted signals are encoded and converted by the shooting thread 122 and stored as multimedia data in a corresponding region of the first buffer 132 (S120). The multimedia data is divided into multiple frame files by the dividing thread 124 according to the size of the checked transmission-available capacity of the MMS server and stored in a corresponding region of the second buffer 134 (step S130).

The inputted multimedia signal is encoded and converted to a file, for example an MP4, of a format suitable for the mobile terminal and then stored. The content of the inputted multimedia signal is then divided and stored in each buffer through the multi-thread, and, when the inputting of the image signal and/or voice signals is completed, the content stored in the multiple buffers is generated as a file.

When the inputting of the image signal and/or voice signals is completed and the inputted multimedia data is all processed, specifically when the inputted image signal and/or voice signals are encoded, divided and stored in the memory unit 130 according to the assigned sequence order by the table unit 126 (S140), the multiple divided frame files are transmitted as an MMS message through the RF unit (S150).

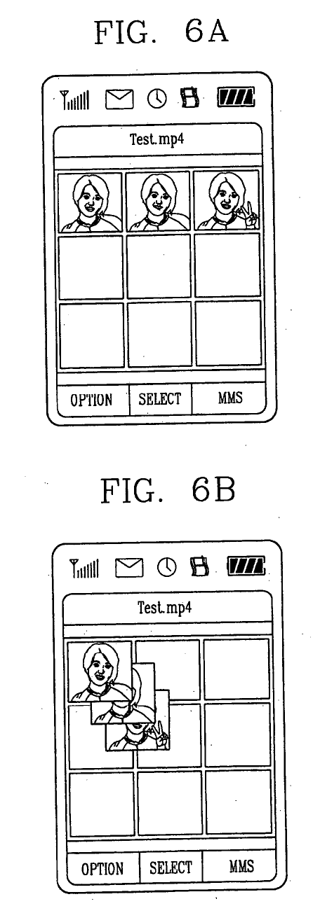

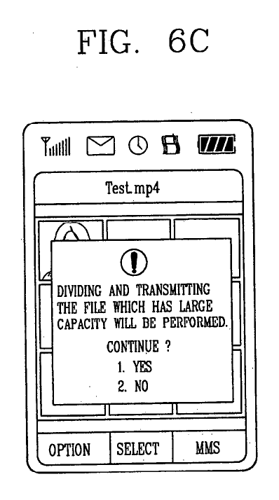

FIG. 6A to 6C illustrate a user interface of a mobile terminal adopting the present invention. As shown in FIG. 6A, the divided-shot image can be shown on a list like each file, but in order to prevent user's confusion, only the first file of successive video can be shown on the list as shown in FIG. 6B. The video file of FIG. 6B can be viewed as one file for a user, but actually, it is the several divided files, and in actual transmitting of MMS, the user can be informed about the divided transmission as shown in FIG. 6C.

When a mobile terminal receives the MMS message, multimedia data such as video is successively reproduced as one file even though multiple files are received. Thus, the receiving user may view the multimedia data without cessation or inconvenience. A header of the MMS message may include information of the divided files, such as the number of files, the order assigned by the table unit and capacity.

As so far described, the apparatus and method for dividing an MMS message in a mobile terminal in accordance with the present invention has many advantages. By dividing and storing multimedia data according to one-time transmission size of MMS, multimedia data as large as available for a mobile terminal may be transmitted as MMS regardless of the transmission (available) capacity of the MMS server, accomplishing commercial effect and users' convenience. In addition, since the buffers for encoding the multimedia data are provided, content of the multimedia data may be stored in the buffers in turn and then when recording is finished, the content of the buffers is generated as a file, thereby preventing loss of multimedia signals and preventing confusion to a user viewing the displayed multimedia signal.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

1. An apparatus for dividing a MMS message in a mobile terminal, the apparatus comprising:
an input unit adapted to receive at least one of an image signal and a voice signal;
a controller adapted to control the mobile terminal, encode the at least one of an image signal and a voice signal received by the input unit into multimedia data, divide the multimedia data into a plurality of multimedia data portions each having a specific size, assign a sequence number to the each of the plurality of multimedia data portions and store the plurality of multimedia data portions;
a buffer unit adapted to store the encoded multimedia data and the plurality of multimedia data portions;
a memory unit adapted to store each of the plurality of multimedia data portions stored in the buffer unit according to the assigned sequence number; and
an RF unit adapted to wirelessly transmit each of the plurality of multimedia data portions stored in the memory unit.

2. The apparatus of claim 1, wherein the input unit comprises at least one of a camera adapted to receive an image signal and a microphone adapted to receive a voice signal.

3. The apparatus of claim 1, further comprising an output unit for outputting operation information of the mobile terminal and at least one of an image signal and a voice signal under the control of the controller.

4. The apparatus of claim 1, wherein the specific size is smaller than a one-time transmission-available capacity of an MMS server.

5. The apparatus of claim 1, wherein the memory unit comprises a RAM and is further adapted to store each of the plurality of multimedia data portions upon receiving a control signal from the controller.

6. The apparatus of claim 1, wherein the controller is further adapted to implement a multi-thread in order to encode the at least one of an image signal and a voice signal into multimedia data, store the multimedia data in the buffer unit, divide the multimedia data into the plurality of multimedia data portions and store the plurality of multimedia data portions the buffer unit.

7. The apparatus of claim 6, wherein the multi-thread comprises:
a shooting thread adapted to receive the at least one of an image signal and a voice signal, store the multimedia data in the buffer unit and output the multimedia data to the output unit; and
a dividing thread adapted to retrieve the multimedia data stored in the buffer unit, divide the retrieved multimedia data into a plurality of multimedia data portions each having a specific size and store the plurality of multimedia data portions in the buffer unit.

8. The apparatus of claim 7, wherein the specific size is smaller than a one-time transmission-available capacity of an MMS server.

9. The apparatus of claim 1, wherein the buffer unit comprises;
a first buffer for temporarily storing the encoded multimedia data; and
a second buffer for dividing and encoding the multimedia data stored in the first buffer to generate the plurality of multimedia data portions and temporarily store the plurality of multimedia data portions under the control of the controller.

10. The apparatus of claim 9, wherein the controller is further adapted to implement a multi-thread in order to encode the at least one of an image signal and a voice signal into multimedia data, store the multimedia data in the first buffer, divide the multimedia data into the plurality of multimedia data portions and store the plurality of multimedia data portions the second buffer.

11. The apparatus of claim 10, wherein the multi-thread comprises:
a shooting thread adapted to receive the at least one of an image signal and a voice signal, store the multimedia data in the first buffer and output the multimedia data to the output unit; and
a dividing thread adapted to retrieve the multimedia data stored in the first buffer, divide the retrieved multimedia data into a plurality of multimedia data portions each having a specific size and store the plurality of multimedia data portions in the second buffer.

12. The apparatus of claim 11, wherein the specific size is below one-time transmission-available capacity of the MMS server.

13. The apparatus of claim 1, wherein the controller further comprises a table unit for defining and assigning a sequence number each of the plurality of multimedia data portions.

14. The apparatus of claim 13, wherein the memory unit comprises a RAM (Random Access Memory), and is further adapted to store each of the plurality of multimedia data portions with a sequence number assigned by the table unit, wherein each of the plurality of multimedia data portions is stored in a corresponding region of the RAM upon receiving a control signal from the controller.

15. A method for dividing an MMS message in a mobile terminal, the method comprising:
determining a transmission capacity of an MMS server when inputting of at least one of an image signal and a voice signal begins;
encoding the at least one of an image signal and a voice signal;
storing the encoded at least one of an image signal and a voice signal as multimedia data in a first buffer;
dividing the multimedia data by the determined transmission capacity of the MMS server to generate multiple frame files;
storing the multiple frame files in a second buffer; and
transmitting the multiple frame files as an MMS message when inputting of the at least one of an image signal and a voice signal is completed.

16. The method of claim 15, further comprising utilizing a multi-thread to perform the encoding and dividing.

17. The method of claim 16, wherein the multi-thread comprises:
a shooting thread for encoding and converting the at least one of an image signal and a voice signal and storing the encoded at least one of an image signal and a voice signal as multimedia data in the first buffer; and
a dividing thread for dividing the multimedia data stored in the first buffer by frame units having a predetermined size and storing the multiple frame files in the second buffer.

18. The method of claim 15, further comprising informing a user of the mobile terminal that the transmitted MMS message comprises multiple frame files.

19. The method of claim 15, further comprising transmitting a header of the MMS message comprising information regarding the multiple frame files being transmitted.

20. The method of claim 19, wherein the header comprises at least one of the number of frame files, an order assigned to the frame files and the determined transmission capacity of the MMS server.
